(19) United States
(12) Patent Application Publication
(10) Pub. No.: US 2007/0246910 A1
(43) Pub. Date: Oct. 25, 2007

(54) Apparatus attached to the back axle of a bicycle used to pull carts or wagons

(76) Inventor: George Michael Copenhaver, Virginia Beach, VA (US)

Correspondence Address: G. Michael Copenhaver, 603 16th Street, Virginia Beach, VA, 23451, US

(21) Appl. No.: 11/410,775

(22) Filed: Apr. 25, 2006

(51) Int. Cl. B62H 7/00

(52) U.S. Cl. 280/293

(57) ABSTRACT

An apparatus which is attached to the back axle of a bicycle used to pull carts, wagons or other similar devices. With a U shaped design made of aluminum or other durable, flexible, lightweight material which is intended to be universal to all bicycles. This apparatus is intended to be attached to the rear axle or frame of a bicycle which allows use without obstructing function of bicycle. The hook up point of the hitch can be a single point or multiple points, static in design or rotating.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of manufacturing and more specifically to an apparatus attached to the back axle of a bicycle used to pull carts. We live on the east coast and have 2 young boys. We love to go to the beach and we prefer to walk or ride our bikes since we only live a few blocks away. On one particular day, my wife was working on the boardwalk at a festival. I wanted to take the boys to stay at the beach all day. Of course that means, towels, umbrella, boogie boards, buckets, food, drinks, sunscreen, scuba masks, and more food. How could I accomplish this feat and still ride my bike to the beach? We have a wonderful heavy duty wooden wagon that has great carrying capacity and suddenly I thought of a way to be able to utilize the wagon and solve my dilemma. I went to my workshop and found a piece of flexible conduit. I shaped it and attached a hook up point. I flattened the ends and cut a slot large enough to attach my new hitch to the rear frame of my bicycle. Soon we were off to the beach, all assundries in the wagon being towed, attached to my new hitch.

What makes this design unique is its attachment point, the rear frame of the bicycle. Other trailers are generally one piece goose neck designs that hook up to the seat of a bicycle. That involves removing the seat to install the trailer. The U shape design of this new hitch allows it to remain attached to the bicycle, without having the hassle of hauling a trailer all the time. It can also be used for other uses. It can be used to pull any type of trailer or fishing cart. I also use it to pull my wife & kids on a skateboard. Other current technology is a one piece gooseneck that fits on to the seat of the bicycle. They are one piece design where the hitch and trailer are connected together as a single unit.

These prior inventions while functional, are cumbersome and limited in use. Since they are single units, the hitch can not be used for other trailers or devices. Most of the devices made are designed for towing a trailer occupied by children. This hitch is not designed for that purpose. This design is intended to be able to utilize your bicycle to tow different loads, groceries, supplies, gear etc utilizing a cart or wagon. Its perfect for the person who wishes to utilize their bicycle in a more versatile way. Until now you could tow your children but if you wanted to buy groceries you were limited to what your baskets could carry. Now you can load up the wagon with larger loads. It is also more convenient to leave the hitch attached and use it when needed versus constantly having your trailer attached or hassling with its removal every time.

### BRIEF SUMMARY OF THE INVENTION

The primary object of the invention is to provide a U shape hitch that does not hinder bike function and can be used to tow carts, trailers or wagons.

Another object of the invention is to provide a hitch that is made of inexpensive, durable and flexible material.

Another object of the invention is to provide a universal design which can be used on any bicycle to tow any cart, wagon or trailer.

A further object of the invention is to provide a hitch that is a quick and easy attachment to rear axle.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus which is attached to the back axle of a bicycle used to pull carts, wagons or other similar devices. comprising: of a U shaped design made of aluminum or other durable, flexible, lightweight material which is intended to be universal to all bicycles. This apparatus is intended to be attached to the rear axle or frame of a bicycle which allows use without obstructing function of the bicycle. The hook up point of the hitch can be at a single point or multiple points in the U shape design and can either be static or dynamic (rotating).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a side view of the invention. A photograph of the current prototype has also been included.

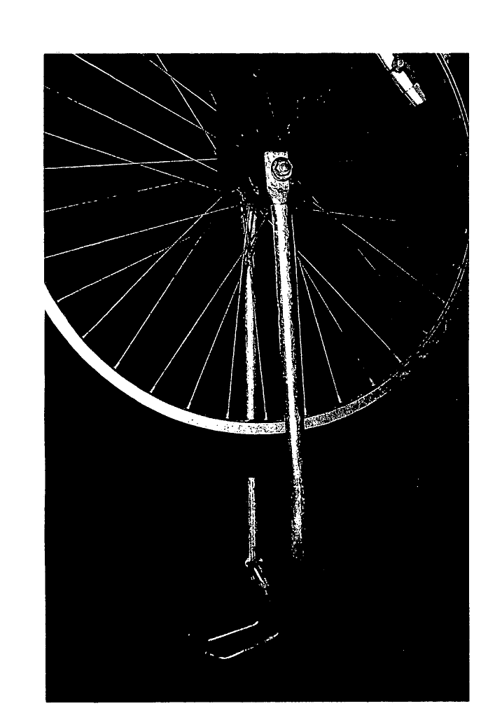

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

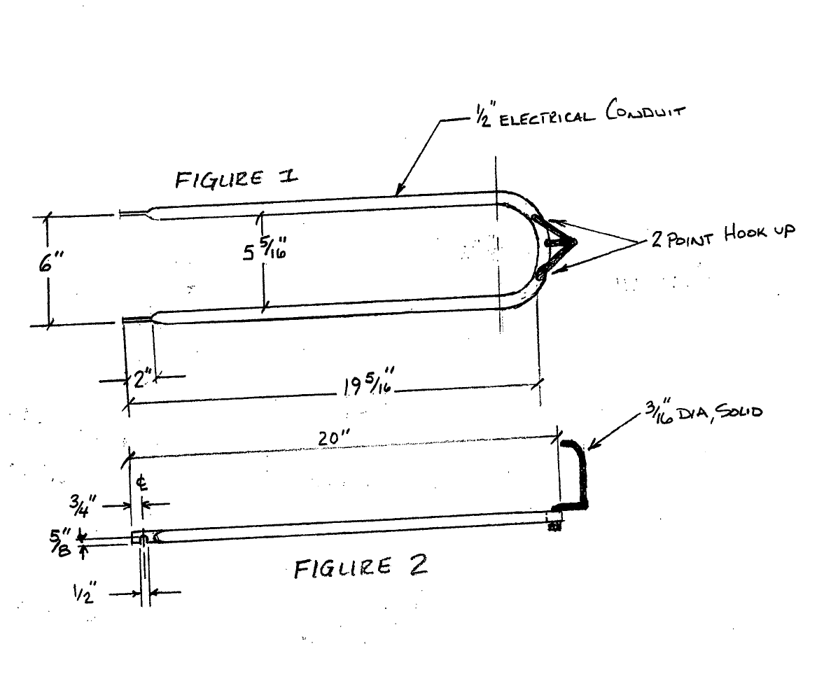

Turning now to the drawings the illustration shows the apparatus in detail. In accordance with the present invention, FIG. 1 shows the basic shape and layout of the apparatus.

The Physical Description of the Bike Toe will be broken down into 2 components, the main body (U shape) and the hook up point.

The main body of the bike toe is ½″ diameter comprised of a flexible, durable, lightweight metal. The metal is then bent at a 180-degree curve (inside radius ˜2 21/32″), which forms a U shape. The total length of the current invention is ˜20″. The length may vary depending on the size of the bicycle. The distance between the walls of the U shape are ˜5½ apart. The attachment point to the rear frame is a 2″ flattened section with a ½″ wide, ⅝″ deep notch. The centerline of the notch is ˜¾″ from flattened end of tubing.

The part of the invention where the cart/wagon is attached is referred to as the “hook up point”. In its current form of the invention, the hook up point is comprised of a 2 prong utility hook attached to the main body with 2 metal screws. The utility hook was placed in the center of the 180-degree curve on the top side of the main body.

This allows a handle to slip over the hook so it can be pulled by the bike. One point of concern is the handle can become unattached due to the forward momentum created by the cart when the bike is stopped. There will be some modifications to this hook up point. A simple bend in the prongs or a locking clasp will prevent this from occurring.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus which is attached to the back axle of a bicycle used to pull carts, wagons or other similar devices. comprising:
of a U shaped design made of aluminum or other durable, flexible, lightweight material which is intended to be universal to all bicycles. This apparatus is intended to be attached to the rear axle or frame of a bicycle which allows use without obstructing function of bicycle. The hook up point of the hitch can be a single point or multiple points, static in design or rotating.
